(19) United States
(12) Patent Application Publication
(10) Pub. No.: US 2013/0156223 A1
(43) Pub. Date: Jun. 20, 2013

(54) SYSTEM AND METHOD FOR INCREASING A FEEDBACK DETECTION RATE IN AN AUDIO SYSTEM

(71) Applicant: Music Group IP Ltd., Tortola (VG)

(72) Inventor: Tian Qian Huang, Shenzhen City (CN)

(73) Assignee: Music Group IP Ltd., Tortola (VG)

(21) Appl. No.: 13/708,542

(22) Filed: Dec. 7, 2012

Related U.S. Application Data
(63) Continuation of application No. PCT/IB2011/001256, filed on Jun. 8, 2011.
(60) Provisional application No. 61/352,450, filed on Jun. 8, 2010.
(60) Provisional application No. 61/352,453, filed on Jun. 8, 2010.

(51) Int. Cl. H04B 15/00

(52) U.S. Cl. CPC H04B 15/00
USPC 381/93

(57) ABSTRACT

A system and method for removing feedback noise in an audio system includes an analyzing unit, which may utilize FFT processing and Feedback signal detection, and an adaptive feedback cancellation unit for removing the feedback noise, which may include, for example, 36 MR notch filters for one channel. A method to detect feedback noise in a substantially short amount of time combines increasing signal characteristics with full scale characteristics to find the feedback signal in a limited amount of time.

### BACKGROUND

1. Technical Field

The present disclosure relates in general to feedback detection and elimination in an audio system and, more particularly, to a system and method for rapid feedback detection and elimination.

2. Description of the Related Art

In the amplification and broadcast of music or other performances, the total content of the broadcast audio signal can be distorted by frequency attenuation, the characteristics of a room, the speaker system or other factor. In general, audio amplification systems use a manual equalizer to compensate the undesired frequency characteristics. The operator can adjust the gain of the frequency band using, for example, a slider attenuator in an equalizer.

Current systems may also contain automatic equalizers which monitor the input signal in real time and set the corresponding equalizer parameters for feedback noise. In these systems, the magnitude of one frequency band in the input signal is typically compared to the magnitude of other frequency bands. The equalizer will become active when the comparison exceeds a certain reference value, the corresponding frequency band would then be attenuated. It is also known that more precise frequency detection can be performed using methods such as interpolation after application of a Fast Fourier Transform.

However, current systems have numerous drawbacks, as they generally must compromise either the speed at which the frequency compensation occurs or the quality of the compensation.

### BRIEF SUMMARY OF THE DISCLOSURE

When a system gains increase very quickly, feedback may occur abruptly, and the noise can be substantial. Thus, the present disclosure provides a fast detection method for detecting fast feedback so that feedback detection and removal can occur quickly when the audio feedback increases quickly.

### BRIEF DESCRIPTION OF THE DRAWINGS

The foregoing and other features and advantages of the present disclosure will be more readily appreciated as the same become better understood from the following detailed description when taken in conjunction with the accompanying drawings wherein:

FIG. 1 is a block diagram of a feedback detection and removal system formed in accordance with the present disclosure;

FIG. 2 is a flowchart illustrating a method of feedback detection and removal in accordance with the present disclosure;

FIG. 3 is a graph of an audio signal with feedback; and

FIG. 4 is a flowchart illustrating a process for fast feedback detection.

### DETAILED DESCRIPTION

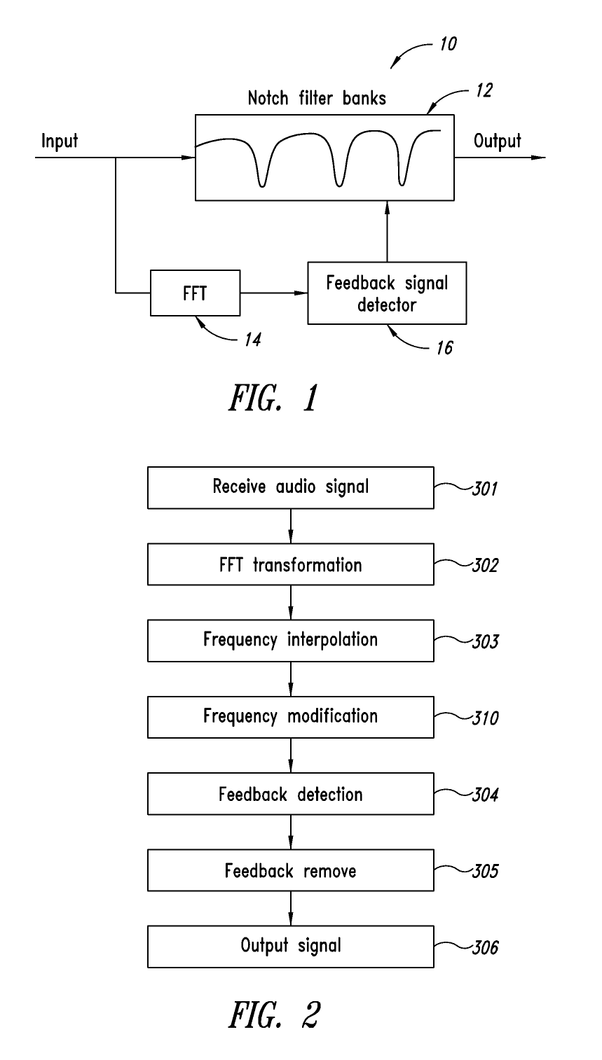

The present disclosure provides a system and method for removing feedback noise in an audio system, and more particularly, in a public announcement system that utilizes a microphone. This system includes an analyzing unit, which may utilize FFT processing and Feedback signal detection, and an adaptive feedback cancellation unit for removing the feedback noise, which may include, for example, 36 IIR notch filters for one channel. One exemplary embodiment of a system 10 formed in accordance with the present disclosure is illustrated in FIG. 1. The system 10 includes an input coupled to a bank of notch filters 12 and in parallel to a Fast Fourier Transform (FFT) block 14. The FFT block 14 has an output coupled to an input of a Feedback signal detector 16 that in turn has an output coupled to the Notch filter bank 12, the output of which forms the output for the system.

FIG. 2 illustrates one embodiment of a flowchart for a frequency removal process in accordance with the method of feedback detection and removal of the present disclosure. As shown therein, the first block 301 indicates reception of an audio signal that is then passed through to FFT transformation 302. Following the FFT transformation 302, the signal goes through Frequency interposition 303 and then Frequency modification 310. Feedback detection 304 occurs after the Frequency modification 310, following which is Feedback removal 306 and then output of the signal 308.

FIG. 3 shows one example of a recorded wave of feedback that occurs and increases abruptly in the time-domain. The time from when the feedback occurs to the time the feedback increases to full scale is 3267 samples, or about 0.07 second. Because there are no harmonics and obvious peak in this feedback, it is difficult to detect the feedback by any prior art method in a sufficiently short amount of time.

To detect the feedback in a sufficiently short amount of time, the present disclosure provides a method to detect feedback noise in a substantially short amount of time. For example, if the feedback signal increases very quickly, it may reach a full scale in a short time, such as 0.1 second. The described process therefore combines the increasing signal characteristics with full scale characteristics to find the feedback signal in a limited amount of time.

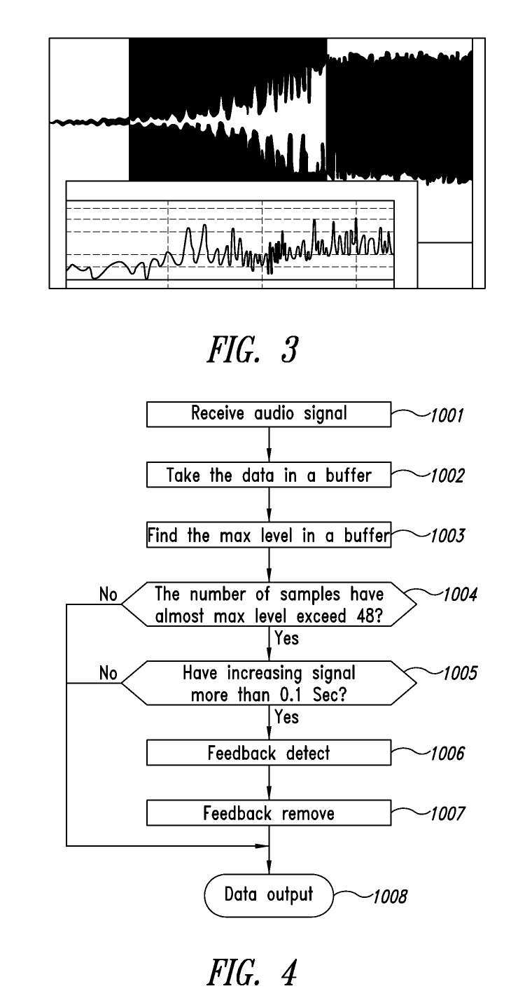

FIG. 4 illustrates one embodiment of a process for performing fast feedback detection. The detected parameters that may be used to detect the onset of feedback or presence of feedback include sound level, max amplitude sample, sound level variation and rise time duration. In the embodiment illustrated in FIG. 4, an audio signal is received in step 1001. The audio signal is then buffered in step 1002, which may include sampling of the audio signal.

In step 1003, the system determines the maximum amplitude sample from the buffer. In step 1004, the system determines the number of samples that have approximately the same level as the max amplitude to decide the condition of the feedback noise. A determination of whether a sample is determined to have approximately the same level as the max amplitude may be based on various factors. Thus, the amount of difference between samples that may be permitted while still considering them to be approximately the same level may be a design choice. In FIG. 4, the process proceeds to step 1005 if the number of samples that are approximately the same level as the max level exceeds 48. However, a different value may also be used.

In step 1005, it is determined if the rise time for the feedback exceeds a predetermined amount of rise time. In FIG. 4, the predetermined amount of rise time is identified as 0.1 seconds, but other values may also be used. The predetermined rise time value represents the amount of time that the magnitude of the input sound level must be larger than the last amplitude and the feedback threshold. If the time that the max level is over or equal to the last max level, the system will determine that an increasing feedback signal is occurring. If the criteria set forth in steps 1004 and 1005 are met, feedback is considered to be detected in step 1006. The feedback is then removed in step 1007. The process for removing the feedback may involve the method described above in connection with FIGS. 2 and 4 any known feedback removal method. The audio is then output in step 1008 with the feedback having been removed.

Based on the above description, a system and method is provided that enables substantially quicker feedback detection to decrease the detrimental effects of feedback on an audio system.

Provisional Patent Application No. 61/352,450 filed on Jun. 8, 2010, and provisional Patent Application No. 61/352,453 filed on Jun. 8, 2010, are both incorporated herein by reference in their entirety.

1. A method for removing feedback noise comprising:
receiving an audio signal;
sampling the audio signal;
determining a maximum level of the audio signal;
determining whether at least a selected number of samples in the audio signal have a level that is approximately that of the maximum level;
determining whether the audio signal includes a signal that is increasing for more than a predetermined amount of time;
determining that feedback noise is occurring if at least a predetermined number of samples in the audio signal have a level that is approximately that of the maximum level and the audio signal includes a signal that is increasing for more than a predetermined amount of time; and
removing the feedback noise from the audio signal.

2. The method of claim 1, wherein determining a maximum level of the audio signal comprises determining a maximum amplitude level of the samples of the audio signal.

3. The method of claim 1, wherein the selected number of samples is 48.

4. The method of claim 1, wherein the predetermined amount of time represents an amount of time that a sound level magnitude of the audio signal is larger than a sound level magnitude of a prior audio signal and the maximum level.

5. A method, comprising:
detecting feedback noise, the detecting including:
receiving an audio signal;
sampling the audio signal to obtain samples;
determining maximum amplitude of the samples of the audio signal;
determining whether at least a number of the samples of the audio signal has an amplitude level that is approximately that of the maximum amplitude level;
determining if the audio signal includes a signal that is increasing in amplitude for more than an amount of time;
determining that feedback is occurring in the audio signal if at least the number of samples in the audio signal have a level that is approximately that of the maximum level and the audio signal includes a signal that is increasing for more than the amount of time; and
removing the feedback from the audio signal.

6. The method of claim 5, wherein the number of the samples is 48.

7. The method of claim 5, wherein the amount of time represents an amount of time that a sound level magnitude of the audio signal is larger than the sound level magnitude of a prior audio signal and the maximum level.

8. A system, comprising:
an analyzing unit configured to perform the following:
receive an audio signal;
sample the audio signal to obtain samples;
determine maximum amplitude of the samples of the audio signal;
determine whether at least a number of the samples of the audio signal have an amplitude level that is approximately that of the maximum amplitude level;
determine if the audio signal includes a signal that is increasing in amplitude for more than an amount of time;
determine that feedback is occurring if at least the number of samples in the audio signal have a level that is approximately that of the maximum level; and
a feedback cancellation unit configured to remove feedback from the audio signal that is detected by the analyzing unit.

9. The system of clam 8, wherein the number of samples is 48.

10. The system of claim 8, wherein the amount of time represents an amount of time that a sound level magnitude of the audio signal is larger than the sound level magnitude of a prior audio signal and the maximum level.

11. The system of claim 8, wherein the adaptive feedback filter comprises a plurality of IIR notch filters.

12. The system of claim 8, wherein the analyzing unit comprises a plurality of channels and each channel has a plurality of IIR notch filters.

13. The system of claim 12 where in the number of IR notch filters per channel is 36.

14. The system of claim 8, wherein the analyzing unit comprises:
an input coupled to the adaptive feedback filter; and
an FFT processing unit having an input coupled to the analyzing unit input and having an output coupled to the adaptive feedback filter.
